(19) United States
(12) Patent Application Publication
(10) Pub. No.: US 2011/0109101 A1
(43) Pub. Date: May 12, 2011

(54) Insta Power

(76) Inventors: Leon Whitney, Kent, OH (US); Carolyn Joyce Whitney, Kent, OH (US)

(21) Appl. No.: 12/474,255

(22) Filed: May 28, 2009

Related U.S. Application Data
(60) Provisional application No. 61/058,259, filed on Jun. 3, 2008.

(51) Int. Cl. H02K 7/18; H02K 53/00

(52) U.S. Cl. 290/1 R; 74/DIG. 9

(57) ABSTRACT

An emergency power source generator, alternator, inverter and gearbox which provides DC power that is then inverted to 110-120V AC power wherein the alternator produces electrical power to charge three 12V batteries set up in tandem via an inverter which is configured to invert the 12V batteries into AC power on a portable frame with wheels and outlets for the portable power.

### PREVIOUS FILING

This application emanates from a previously filed application 61/058,259 Filed Jun. 3, 2008

### FIELD OF THE INVENTION

The present invention relates to generators, specifically to an emergency power generator

### BACKGROUND OF THE INVENTION

In electricity generation, an electrical generator is a device that converts mechanical energy to electrical energy, generally using electromagnetic induction. The reverse conversion of electrical energy into mechanical energy is done by a motor, and motors and generators have many similarities. The source of mechanical energy may be a reciprocating or turbine steam engine, water falling through a turbine or waterwheel, an internal combustion engine, a wind turbine, a hand crank, the sun or solar energy, compressed air or any other source of mechanical energy.

The generator moves an electric current, but does not create electric charge, which is already present in the conductive wire of its windings. It is somewhat analogous to a water pump, which creates a flow of water but does not create the water inside. Other types of electrical generators exist, based on other electrical phenomena such as piezoelectricity, and magneto hydrodynamics. The construction of a dynamo is similar to that of an electric motor, and all common types of dynamos could work as motors. An engine-generator is the combination of an electrical generator and an engine (prime mover) mounted together to form a single piece of self-contained equipment. The engines used are usually piston engines, but gas turbines can also be used. Many different versions are available—ranging from very small portable petrol powered sets to large turbine installations.

Accordingly, there exists a need for generator that solves one or more of the problems herein described or that may come to the attention of one skilled in the art after becoming familiar with this specification.

### SUMMARY OF THE INVENTION

The Insta-Power has three batteries, which are all connected in parallel. The positive terminal of the first battery is connected to the positive input of the twelve volt, twenty-five hundred watt inverter, and the positive terminal of the second battery. The negative terminal of the first battery is connected to the negative input of the inverter, and the negative terminal of the second battery. The positive terminal of the second battery is connected to the positive terminal of the first battery, and the positive terminal of the third battery. The positive terminal of the second battery is also connected to the line side of the ten amp fuse, and the input of the A plus terminal on the voltage regulator. The negative terminal of the second battery is connected to the negative terminal of the first battery and the negative terminal of the third battery. The negative terminal of the second battery is also connected to the frame of the voltage regulator for bonded grounding. The positive terminal of the third battery is connected to the positive terminal of the second battery, and the positive terminal of the alternator. The negative terminal of the third battery is connected to the negative terminal of the second battery, and the negative terminal of the alternator. The negative terminal of the third battery is also connected to the mounting rack for bonded grounding.

The inverter is twenty-five hundred watts at twelve volts. The positive input terminal is connected to the positive terminal of the first battery. The negative input terminal is connected to the negative terminal of the first battery. The AC output side of the inverter feeds a one-hundred fifteen volt AC motor.

The motor is a two horse power, one hundred fifteen volt AC, which rotates at three thousand four hundred fifty RPM's. The motor shaft is connected to a coupler. The input power to the motor is fed from the output AC source of the inverter.

The gearbox is a one point five to one ratio. The shaft input side of the gearbox is connected to the other end of the coupler, which is attached to the motor shaft. A two inch pulley is attached to the shaft of the load side of the gearbox, which rotates the pulley of the alternator at two thousand three hundred RPM's.

### BRIEF DESCRIPTION OF THE DRAWING

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a diagram of a generator, according to on embodiment of the invention;

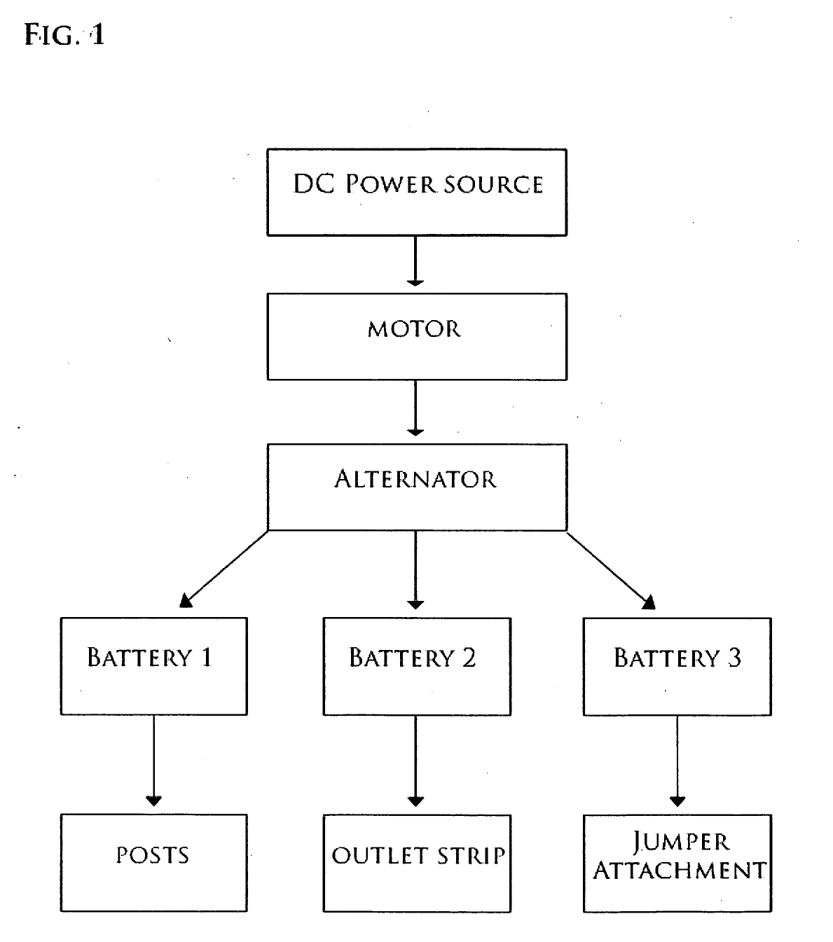

FIG. 2 is a diagram of a generator, according to one embodiment of the invention;

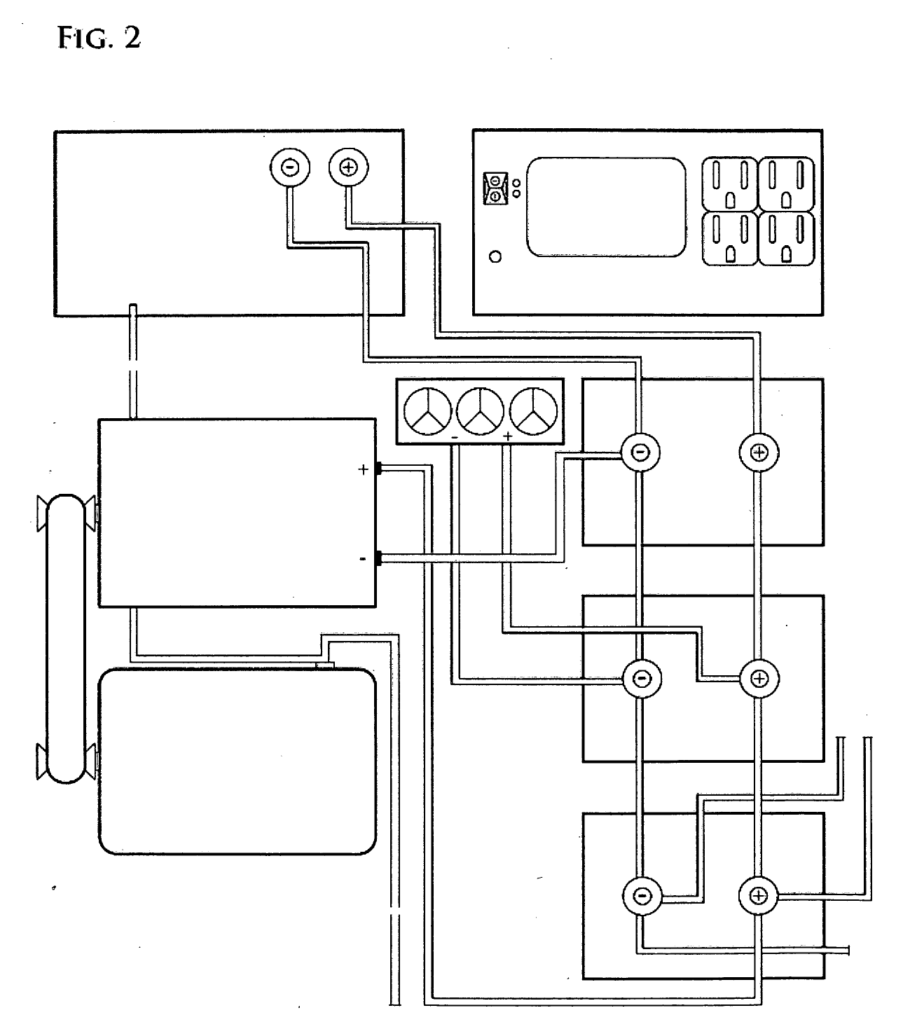

FIG. 3 is a rear perspective view of a generator, according to one embodiment of the invention; and

FIG. 4 is a side perspective view of a generator, according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

Looking to the figures, an emergency power source generator according to one embodiment comprises a 12V battery. The 12V battery provides a DC power source that is then inverted to 110-120V AC power through an 110V electric motor. The electric motor is in electrical communication with an alternator. The alternator is configured to produce electrical power from the AC power to charge three 12V batteries set up in tandem. The alternator may be replaced by a 12V DC generator and still perform its intended function. The 12V batteries are configured to supply 12V of DC power to an inverter, wherein the inverter is configured to invert the 12V batteries into AC power.

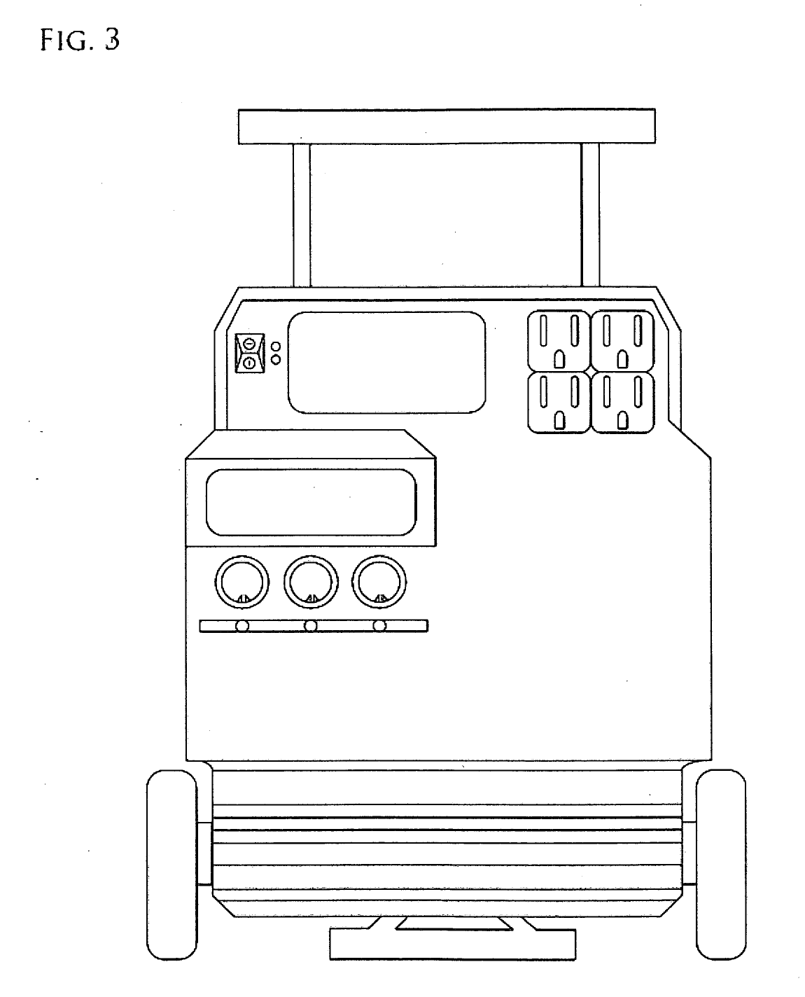

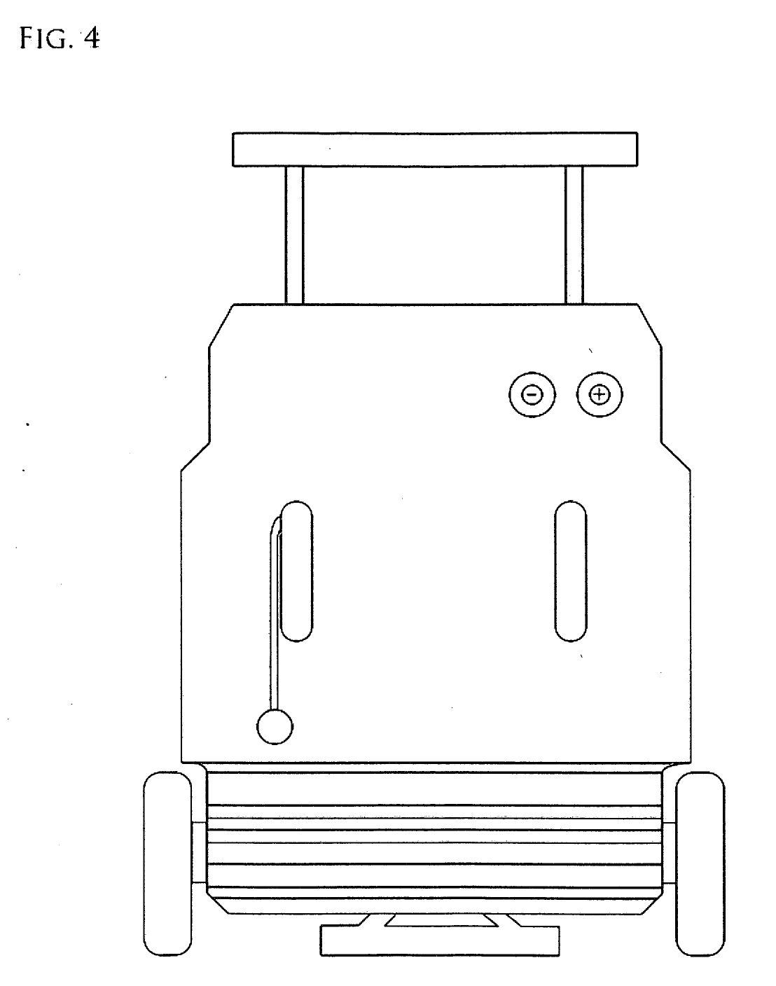

The AC power is configured to supply power to a plurality of electrical sockets of various configurations. Non-limiting examples of electrical sockets may be an electrical post, an outlet strip, an electrical socket, an electrical output, or a jumper attachment. As illustrated in FIGS. 3 and 4, the emergency power source generator, according to one embodiment, wherein the generator includes a portable frame. The portable frame includes a set of wheels and a handle, configured to transport the generator. As illustrated in FIG. 3, the generator also includes a plurality of electrical sockets and a digital/analog dial configured to display available power. FIG. 3 further illustrates an on/off button configured to turn on and off the generator. As illustrated in FIG. 4, the generator includes a pair of jumper cable connection ports, configured to supply power to a jumper cable. The generator also includes a jumper cable bracket configured to secure and store a pair of jumper cables. Further illustrated in FIG. 4, the generator includes an electrical output and a bracket configured to secure and support the electrical outlet

In operation of one embodiment of the invention, an user starts the generator, wherein the 12 Volt DC power source inverted into a 110 to 120 Volt AC power source. The 110 to 120 Volt AC power source feeds into an 110 to 120 Volt electrical motor, wherein the electrical motor produces 1725 PRM. The electrical motor runs an alternator that produces 12 to 15 Volt of DC power. The alternator feeds power to three 12 Volt batteries, wherein the batteries are in a tandem configuration. The batteries supply 12 Volts of power to an inverter which produces AC power. The AC power is in electrical communication with a plurality of electrical outlets. The user is able to couple a device to one of the electrical outlets and draw power to use the device.

In operation of another embodiment of the invention, a user starts the generator and couples a jumper cable to the jumper cable bracket. In use, the user couples one of the jaws of the jumper cables to the positive and negative ends of the jumper cable attachments, and the other end to a vehicle, wherein the vehicle's battery is low on power.

The following non-limiting references are included for their supported teachings herein: U.S. Pat. No. 5,570,001, issued to Fenley; U.S. Pat. No. 7,045,913, issued to Ebrahim et al.; U.S. Pat. No. 4,412,170, issued to Roesel Jr.; U.S. Pat. No. 5,115,183, issued to Kyoukane; U.S. Pat. No. 4,119,862, issued to Gocho; U.S. Pat. No. 6,392,380, issued to Furukawa et al.; U.S. Pat. No. 5,589,743, issued to King ; U.S. Pat. No. 7,012,822, issued to Zhu et al.; U.S. Pat. No. 4,647,835, issued to Fujikawa et al.; U.S. Pat. No. 6,091,160, issued to Kouchi et al.; U.S. Pat. No. 6,100,599, issued to Kouchi et al.; U.S. Pat. No. 6,119,636, issued to Fan; U.S. Pat. No. 4,746,808, issued to Kaeser.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the figures illustrate a portable frame with a set of wheels and a handle. One skilled in the art would appreciate that the generator may be enclosed in a backpack. The backpack configuration may be carried just like a backpack and still provide power through electrical outputs disposed about the backpack.

Additionally, although the figures illustrate a plurality of electrical outlets, jumper cable attachments, brackets, switches, displays, and electrical outputs may vary in design, configuration, size, power, disposition, and still perform its intended function.

It is also envisioned that the portable frame may vary in size, shape, design, configuration, and still perform its intended function. Finally, it is envisioned that the components of the device may be constructed of a variety of materials, such as but not limited to: metal, metal, alloys, textiles, graphite, and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the functions, features, structures, and/or methods described herein.

What is claimed is:

1. An emergency power source generator, comprising:
a) a 12V battery providing DC power that is then inverted to 110-120V AC power;
b) a 110V electric motor in electrical communication with the AC power;
c) an alternator, in electrical communication with the 110V electrical motor, wherein the alternator produces electrical power to charge three 12V batteries set up in tandem;
d) an inverter configured to invert the 12V batteries into AC power;
e) a portable frame with wheels;
f) a plurality of electrical output sockets of various types to allow a user to draw extra power therefrom;
g) a pair of jumper cable connection ports;
h) an on/off switch; and
i) a digital/analog dial configured to display available power.
